(19) United States
(12) Patent Application Publication
(10) Pub. No.: US 2012/0056855 A1
(43) Pub. Date: Mar. 8, 2012

(54) INTERFEROMETRIC DISPLAY DEVICE

(75) Inventors: Wenyue Zhang, San Jose, CA (US); Alok Govil, Santa Clara, CA (US); Ming-Hau Tung, San Francisco, CA (US); Yi Tao, San Jose, CA (US)

(73) Assignee: QUALCOMM MEMS Technologies, Inc., San Diego, CA (US)

(21) Appl. No.: 13/011,571

(22) Filed: Jan. 21, 2011

Related U.S. Application Data
(60) Provisional application No. 61/379,910, filed on Sep. 3, 2010.

(51) Int. Cl. G09G 5/00; B05D 5/12; G02B 26/00

(52) U.S. Cl. 345/204; 359/290; 427/58

(57) ABSTRACT

This disclosure provides systems, methods, and apparatus including one or more capacitance control layers to decrease the magnitude of an electric field between a movable layer and an electrode. In one aspect, a display device includes an electrode, a movable layer, and a capacitance control layer. At least a portion of the movable layer can be configured to move toward the electrode when a voltage is applied across the electrode and the movable layer and an interferometric cavity can be disposed between the movable layer and the first electrode. The capacitance control layer can be configured to decrease the magnitude of an electric field between the movable layer and the electrode when the voltage is applied across the movable layer and the electrode.

### CROSS-REFERENCE TO RELATED APPLICATIONS

This disclosure claims priority to U.S. Provisional Patent Application No. 61/379,910, filed Sep. 3, 2010, entitled “INTERFEROMETRIC DISPLAY DEVICE,” and assigned to the assignee hereof. The disclosure of the prior application is considered part of, and is incorporated by reference in, this disclosure.

### TECHNICAL FIELD

This disclosure relates to electromechanical systems and display devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the present disclosure each have several innovative aspects, no single one of which is solely responsible for the desirable attributes disclosed herein.

One innovative aspect of the subject matter described in this disclosure can be implemented in a display device including a first electrode, a movable layer, and a first capacitance control layer. At least a portion of the movable layer can be configured to move toward the first electrode when a first voltage is applied across the first electrode and the movable layer. An interferometric cavity can be disposed between the movable layer and the first electrode. The first capacitance control layer can be configured to decrease the magnitude of a first electric field between the movable layer and the first electrode when the voltage is applied across the movable layer and the first electrode. The first capacitance control layer can be disposed on a portion of the movable layer and positioned at least partially between the first electrode and the movable layer. The first capacitance control layer can be at least partially transmissive. The capacitance control layer can be configured to decrease the magnitude of a first electric field between the movable layer and the first electrode when the first voltage is applied across the movable layer and the first electrode. The device can also include a second electrode, with a portion of the movable layer being between the first electrode and the second electrode, and a second capacitance control layer disposed on the movable layer between the second electrode and the movable layer.

In one aspect, the first electrode can include a conductive layer and an absorber layer that is at least partially transmissive. In another aspect, the display device also can include a second electrode and a portion of the movable layer can be disposed between the first electrode and the second electrode. In some aspects, the movable layer can be configured to move toward the second electrode when a second voltage is applied between the second electrode and the movable layer and the device can further include a second capacitance control layer disposed on a portion of the movable layer. The second capacitance control layer can be positioned at least partially between the second electrode and the movable layer and can be configured to decrease the magnitude of a second electric field between the movable layer and the second electrode when the second voltage is applied across the movable layer and the second electrode. In some aspects, the first capacitance control layer can include a dielectric material, for example, silicon dioxide or silicon oxynitride. The first capacitance control layer can have a thickness dimension between about 100 nm and about 4000 nm. Additionally, the first capacitance control layer can have a thickness dimension that is about 150 nm and the first capacitance control layer and the first electrode can define an air gap therebetween having a thickness dimension between about 300 nm and about 700 nm.

Another innovative aspect of the subject matter described in this disclosure can be implemented in a display device including an electrode, means for interferometrically modulating light, and control means for decreasing the magnitude of an electric field between the electrode and the modulating means when a voltage is applied across the modulating means and the electrode. At least a portion of the modulating means can be configured to move toward the first electrode when a voltage is applied across the first, electrode and the modulating means and an interferometric cavity can be disposed between the modulating means and the first electrode. The control means can be disposed on a portion of the modulating means and positioned at least partially between the electrode and the modulating means. The control means can be at least partially transmissive. In one aspect, the electrode includes means for absorbing light and can be at least partially transmissive. In one aspect, the control means can include a dielectric material.

Another innovative aspect of the subject matter described in this disclosure can be implemented in a display device including a first electrode, an absorber layer disposed at least partially on the first electrode, the absorber layer being at least partially transmissive, a movable layer disposed such that at least a portion of the absorber layer is positioned between at least a portion of the movable layer and at least a portion of the first electrode, at least a portion of the movable layer can be configured to move toward the first electrode when a voltage is applied across the first electrode and the movable layer, an interferometric cavity defined between the movable layer and the absorber layer, and a first capacitance control layer configured to decrease the magnitude of a first electric field between the movable layer and the first electrode when the voltage is applied across the movable layer and the first electrode, the first capacitance control layer being disposed on a portion of the absorber layer, the first capacitance control layer being positioned at least partially between the absorber layer and the movable layer, the first capacitance control layer being at least partially transmissive. In one aspect, the device also can include a second electrode and a portion of the movable layer can be disposed between the first electrode and the second electrode. The device also can include a second capacitance control layer disposed on a portion of the second electrode and positioned at least partially between the second electrode and the movable layer.

Another innovative aspect of the subject matter described in this disclosure can be implemented in a display device including an electrode, a movable layer, and a capacitance control layer configured to decrease the magnitude of an electric field between the movable layer and the electrode when a voltage is applied across the movable layer and the electrode. At least a portion of the movable layer can be configured to move toward the electrode when a voltage is applied across the first electrode and the movable layer and an interferometric cavity can be defined between the first electrode and the movable layer. The movable layer can include a first portion, a second portion that is offset from the first portion, and a step between the first portion and the second portion. The capacitance control layer can be disposed on the second portion of the movable layer and positioned at least partially between the electrode and the movable layer. In one aspect, the capacitance control layer includes a dielectric material and the capacitance control layer can be at least partially transmissive.

One innovative aspect of the subject matter described in this disclosure can be implemented in a method of manufacturing a display device. The method can include providing a first electrode, forming a first sacrificial layer over the first electrode, forming a first capacitance control layer over the sacrificial layer, and forming a movable layer over the first sacrificial layer. In some implementations, the method can include forming a first protective layer between the first sacrificial layer and the first capacitance control layer. In another implementation, the method can include forming a second sacrificial layer over the movable layer, positioning a second electrode over the second sacrificial layer, and removing the first and second sacrificial layers. In some aspects, the method can include forming a second capacitance control layer between the movable layer and the second sacrificial layer and forming a second protective layer between the second capacitance control layer and the second sacrificial layer.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a cross-section of a three-terminal interferometric modulator which is voltage driven and in which the movable layer is shown in a relaxed position.

FIG. 9B shows an example of a cross-section of a three-terminal interferometric modulator which is charge driven and in which the movable layer is shown in a relaxed position.

FIG. 9C shows an example of a diagram illustrating a simulation of the deflection of a movable layer as the charge applied on the movable layer is changed by different voltages applied by a control circuit.

FIG. 9D shows an example of a cross-section of a three-terminal interferometric modulator configured to drive a movable layer through a range of states (or positions).

FIG. 10A shows an example of a cross-section of a three-terminal interferometric modulator with a capacitance control layer disposed on the movable layer between the movable layer and the upper electrode.

FIG. 10B shows an example of a cross-section of a three-terminal interferometric modulator with a first capacitance control layer disposed on the movable layer between the movable layer and the upper electrode and a second capacitance control layer disposed on the movable layer between the movable layer and the lower electrode.

FIG. 10C shows an example of a cross-section of the interferometric modulator of FIG. 10A with a protective layer disposed on the capacitance control layer.

FIG. 10D shows an example of a cross-section of a three-terminal interferometric modulator with a capacitance control layer disposed on the upper electrode between the movable layer and the upper electrode.

FIG. 10E shows an example of a cross-section of a three-terminal interferometric modulator with a capacitance control layer disposed on the lower electrode between the movable layer and the lower electrode.

FIG. 10F shows an example of a cross-section of a three-terminal interferometric modulator with a first capacitance control layer disposed on the upper electrode between the movable layer and the upper electrode and a second capacitance control layer disposed on the lower electrode between the movable layer and the lower electrode.

FIG. 11 shows an example of a flow diagram illustrating a method of making an interferometric display.

FIG. 12A shows an example of a cross-section of a two-terminal interferometric modulator in which the movable layer is in a relaxed position.

FIG. 12B shows an example of a cross-section of a two-terminal interferometric modulator in which is a capacitance control layers is disposed on the movable layer between the electrode and the movable layer.

FIG. 12C shows an example of a cross-section of a two-terminal interferometric modulator in which the movable layer includes a first portion and a second portion that is offset from the first portion and in which a capacitance control layer is disposed on the second portion of the movable layer between the electrode and the movable layer.

FIGS. 13A and 13B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

Some implementations of interferometric modulator (IMOD) display devices can include a movable reflective layer that is configured to move through a cavity so the movable layer is positioned relative to one or more partially reflective/partially transmissive layers to change an optical characteristic of the display device. In some interferometric modulator displays (for example, analog displays) it can be desirable for the movable layer to move to various selected positions relative to a partially reflective/partially transmissive layer, each position placing the modulator into a particular “state” which has certain light reflectance properties such that the modulator can reflect light selectively over a wide range of the optical spectrum. For example, an analog interferometric modulator display can be configured to change between a red state, a green state, a blue state, a black state, and a white state by moving the movable layer into certain positions, each of the red, green, blue, black and white colored states corresponding to a perceivable color reflective state of the display device. As the drive voltage on the interferometric modulator device is increased, the movable layer moves closer to a partially reflective/partially transmissive layer due to electrostatic forces. As the movable layer moves closer to the partially reflective/partially transmissive layer, the strength of the electrostatic force between the movable layer and the partially reflective and partially transmissive layer increases faster than the mechanical restoration force of the movable layer increases. As the drive voltage on the interferometric device is varied incrementally, the movable layer moves to a new position and the electrical and mechanical restoring forces balance one another. In some implementations, once the deflection of the movable layer crosses a certain e.g., predefined, threshold, the electrical force can be unconditionally greater than the mechanical restoring force, which can result in causing the movable layer to move in close proximity to the partially reflective and partially transmissive layer. In some implementations, interferometric modulator displays can become unstable once the deflection of the movable layer crosses this threshold. Accordingly, it can be desirable to maximize the distance that a movable layer can move through the cavity. As used herein “stably move” or “stable movement” refers to the movement of a movable layer when the mechanical restoration force of the movable layer has not been overcome by an electrostatic force.

In some implementations, an interferometric display device can include one or more capacitance control layers disposed between a movable layer and an electrode (used for driving the movable layer) to decrease the magnitude of the electric field therebetween. Decreasing the magnitude of the electric field between a movable layer and a driving electrode can decrease the magnitude of a resulting electrostatic force and can allow the movable layer to move closer to the electrode in a controllable manner. In some implementations, without the effect of the two opposite forces, the mechanical restoration force and the electrostatic driving force can become uncontrollable or unstable. The decreased electric field facilitates the movable layer moving in a controlled manner a greater distance through the cavity and through more states (positions relative to a corresponding reflective layer of the device), which can allow reflectance over a wider range of the optical spectrum. In some implementations, the capacitance control layers can include one or more layers of dielectric materials having dielectric constants that decrease the magnitude of an electric field within the volume of the material.

Particular implementations of the subject matter described in this disclosure can be implemented to realize one or more of the following potential advantages. Some implementations described herein provide interferometric modulators with one or more capacitance control layers that decrease the magnitude of an electric field between a movable layer and an electrode. Decreasing the magnitude of an electric field between a movable layer and an electrode can increase the stability of the interferometric display. For example, decreasing the magnitude of the electric field can allow the movable layer to move closer to the electrode without an electrostatic force acting on the movable layer to overcome a mechanical restoration force of the movable layer. Additionally, increasing the stable range of motion of a movable layer can result in reflectance from the interferometric display over a wider range of the optical spectrum.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the height of the optical resonant cavity, i.e., by changing the position of the reflector.

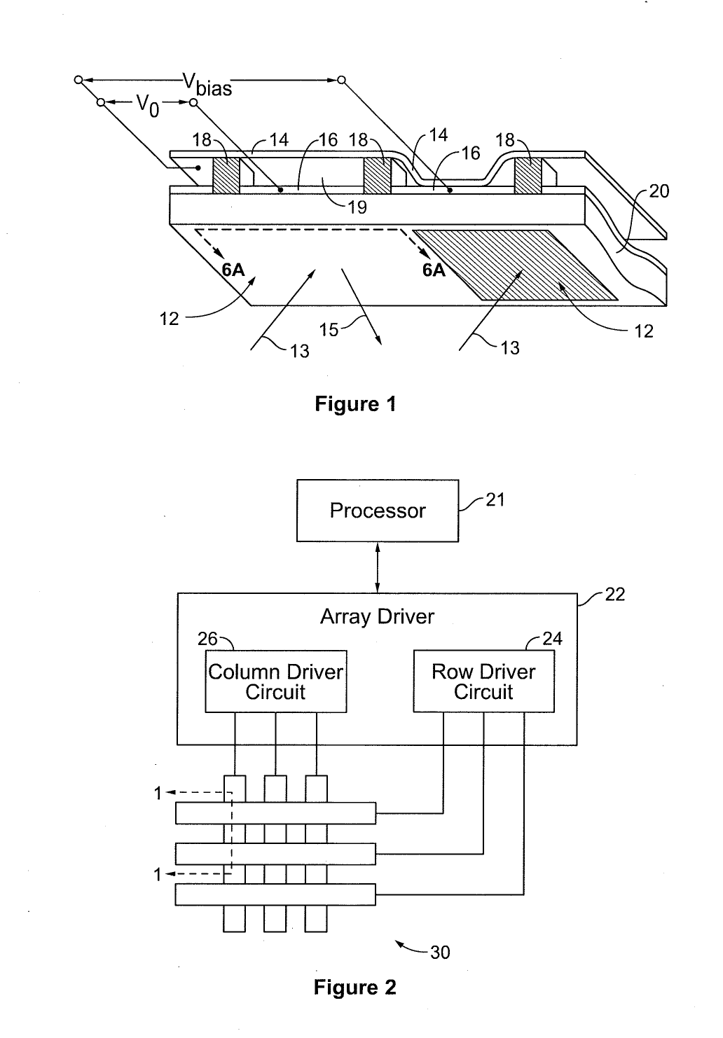

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

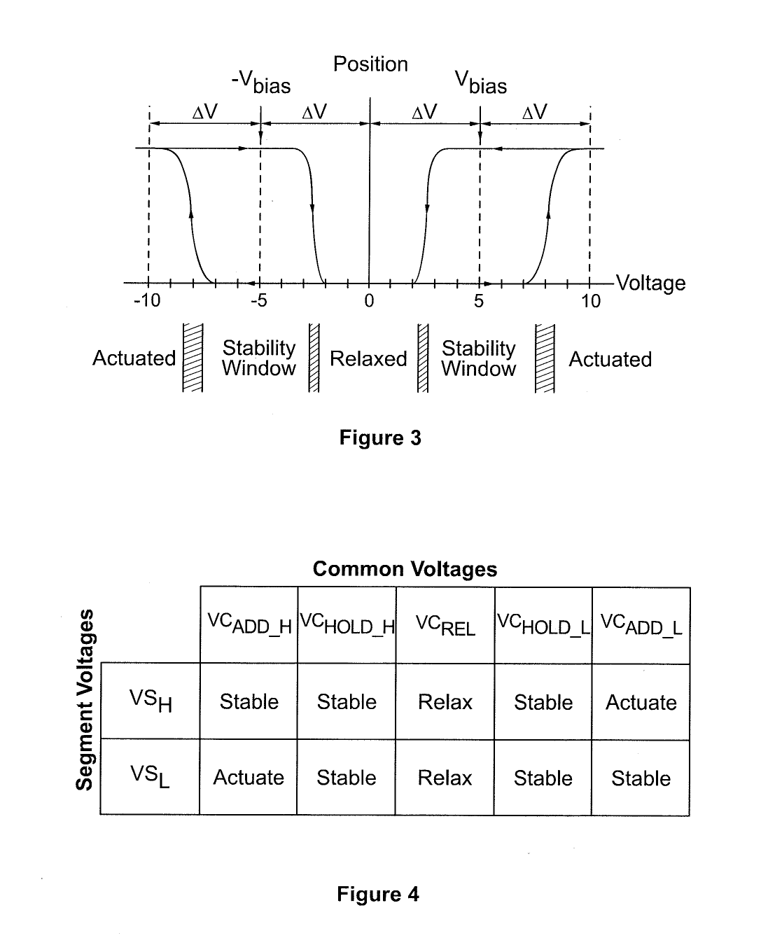

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

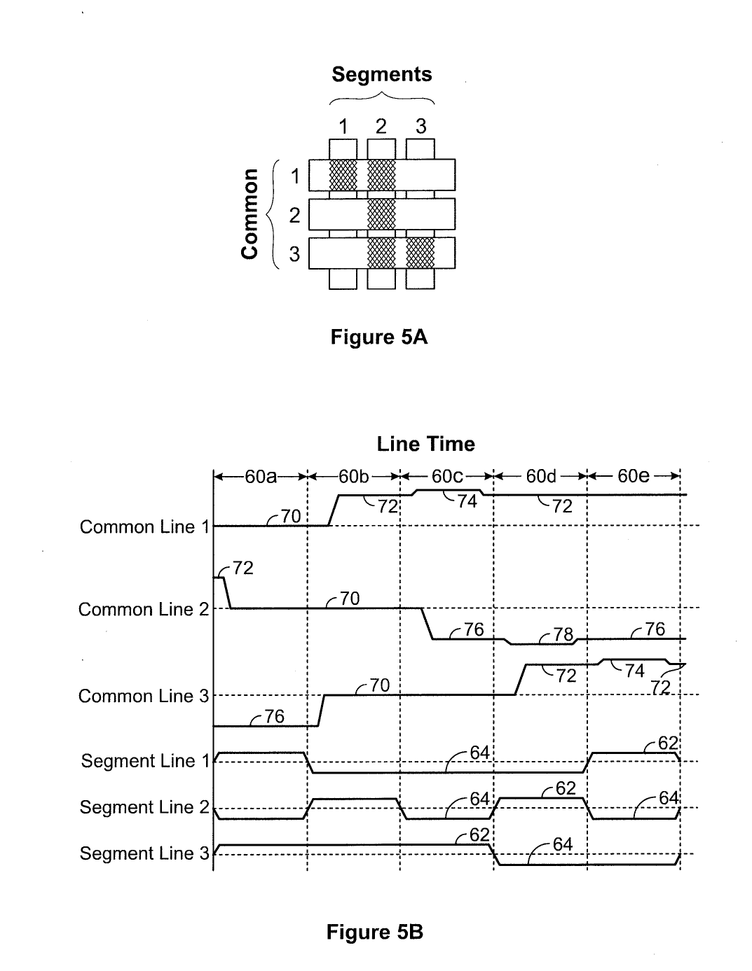

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

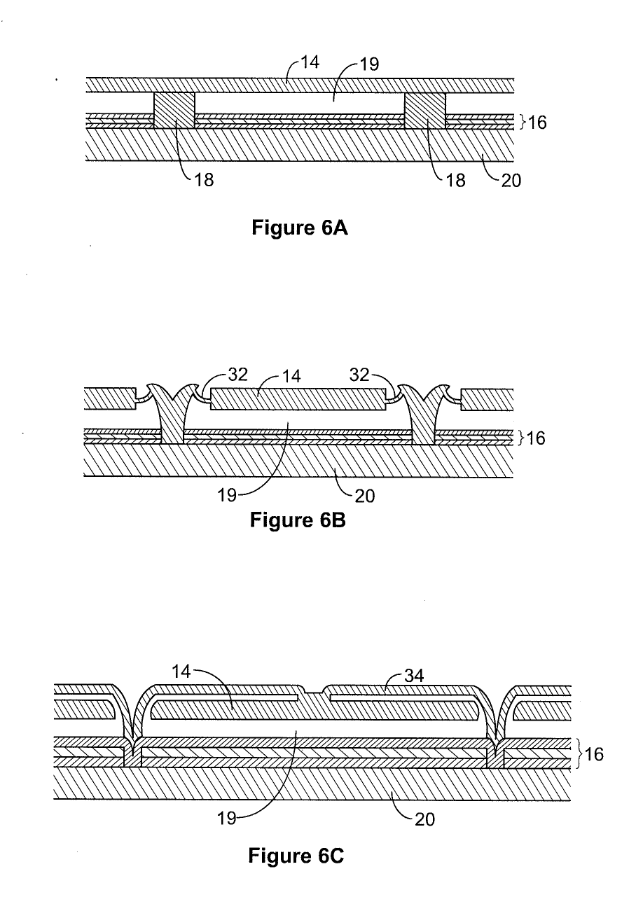

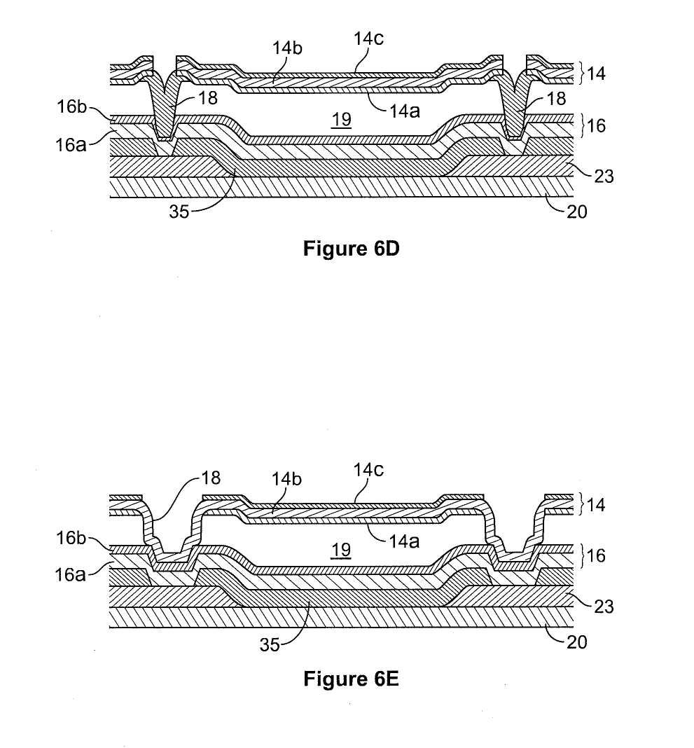

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CFO and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure.

In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

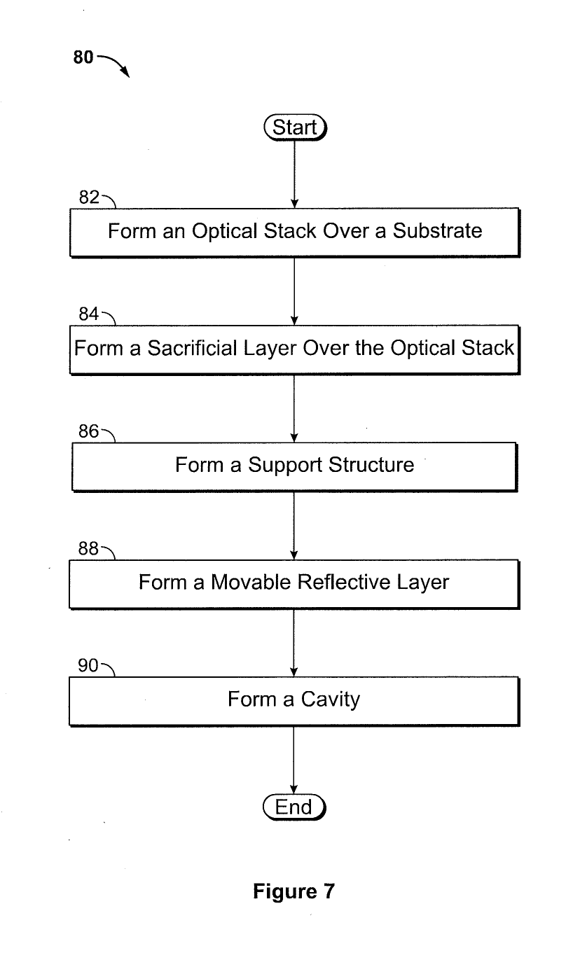

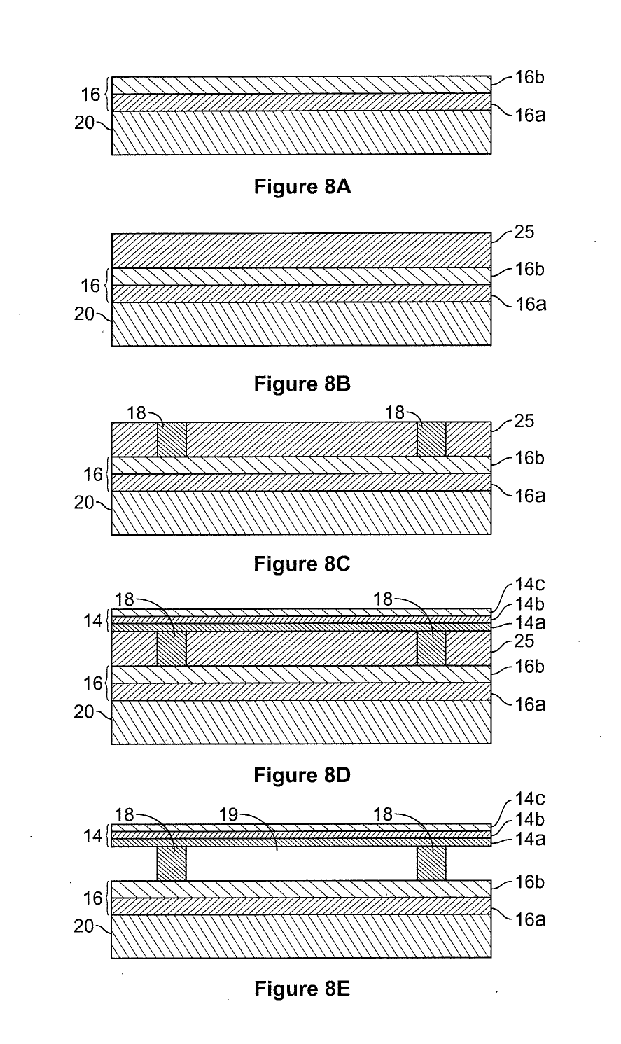

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size (e.g., height). Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

The interferometric modulators described in reference to FIGS. 8A-8E are bi-stable display elements having a relaxed state and an actuated state. Certain interferometric modulators can be implemented as analog interferometric modulators. Analog interferometric modulators can be configured and driven to have more than two states. For example, in one implementation of an analog interferometric modulator, a single movable layer can be positioned at any gap height between the highest and lowest positions to change the height of an optically resonant gap such that the interferometric modulator can be placed into various states that each reflect a certain wavelength of light. Each wavelength of reflected light corresponds to a color or mixture of colors. For example, such a device can have a red state, a green state, a blue state, a black state, and a white state. Accordingly, a single interferometric modulator can be configured to have different light reflectance properties over a wide range of the optical spectrum. Further, the optical stack of an analog interferometric modulator may differ from the bi-stable display elements described above, and these differences may produce different optical results. For example, in the bi-stable elements described above, the closed state gives the bi-stable element a darkened black reflective state. In some implementations, analog interferometric modulators can include an absorber layer and be configured to have a white reflective state when the movable layer is positioned near the absorber layer.

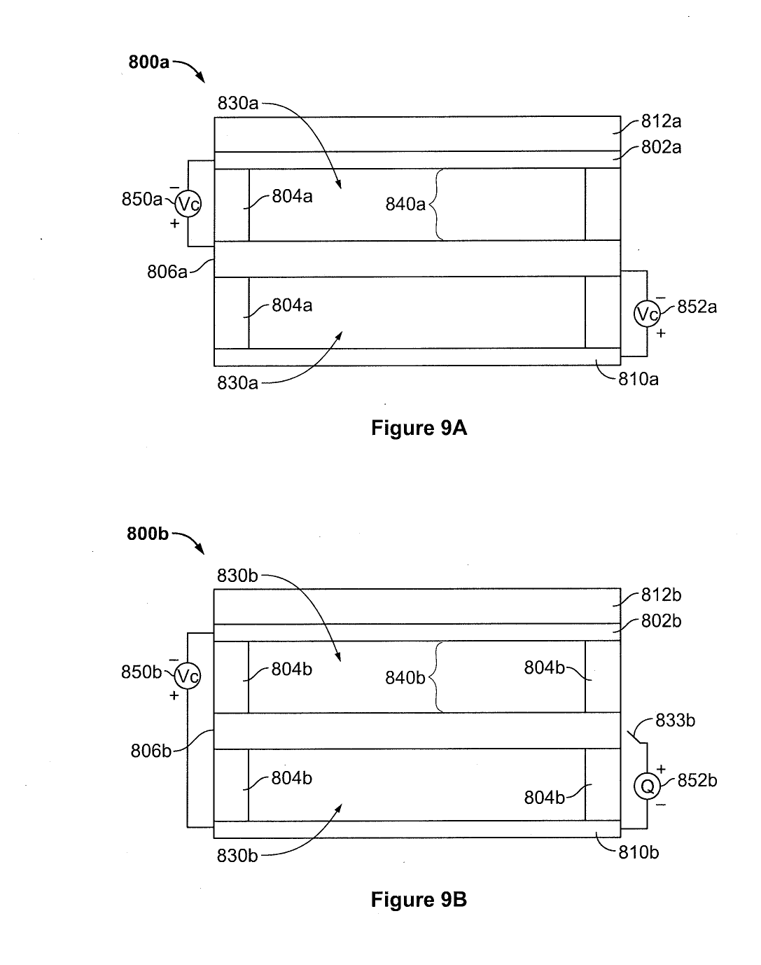

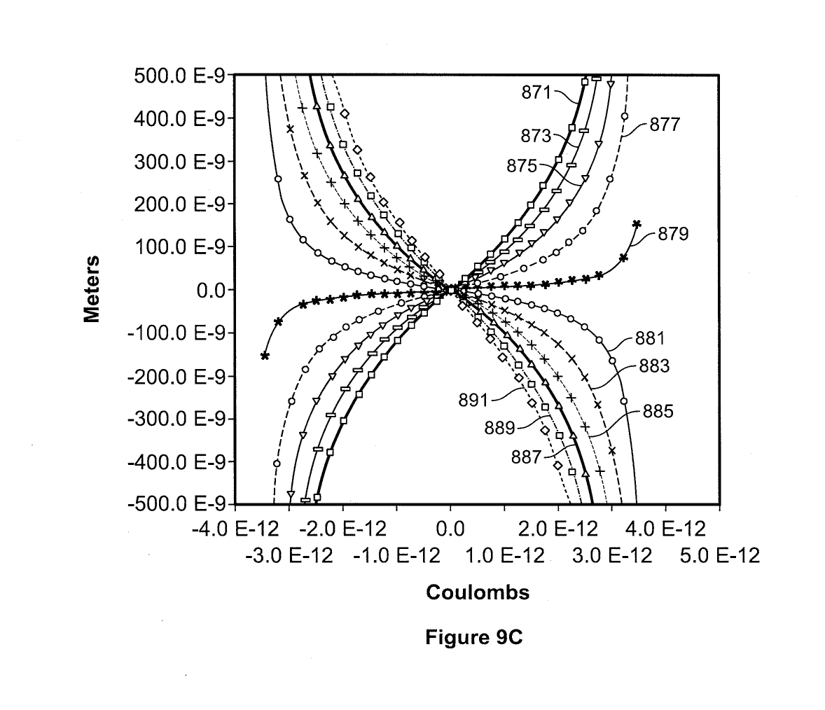

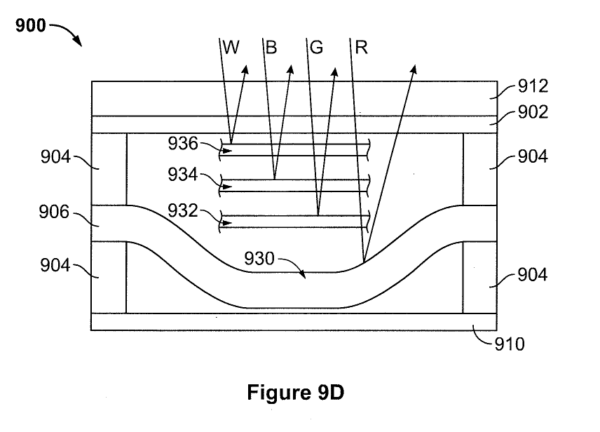

FIG. 9A shows an example of a cross-section of a three-terminal interferometric modulator which is voltage driven and in which the movable layer 806a is shown in a relaxed (or unactuated) position. The modulator 800a includes an upper electrode 802a and a lower electrode 810a. As one having skill in the art will appreciate, the terms “upper” and “lower” are sometimes used for ease of describing the figures, and indicate relative positions corresponding to the orientation of the figure on a properly oriented page, and may not reflect the proper orientation of the IMOD as implemented. The upper and lower electrodes 802a, 810a are formed of conductive materials. In one implementation, the electrodes 802a, 810a are one or more metal layers. The modulator 800a also includes the movable layer 806a that is disposed at least partially between the upper electrode 802a and the lower electrode 810a.

The movable layer 806a illustrated in FIG. 9A can include a metallic layer that is reflective and conductive. In some implementations, the movable layer 806a can include a plurality of layers including a reflective layer, a conductive layer, and a membrane layer which is disposed between the reflective layer and the conductive layer. The movable layer 806a can include various materials including, for example, aluminum, copper, silver, molybdenum, gold, chromium, alloys, silicon oxy-nitride, and/or other dielectric materials. The thickness of the movable layer 806a can vary based on a desired implementation. In one implementation, the movable layer 806a has a thickness between about 20 nm and about 100 nm. In some implementations, a membrane layer disposed between the reflective and conductive layer can be formed of one or more dielectric material.

The upper electrode 802a, lower electrode 810a, and movable layer 806a each form a terminal of the interferometric modulator 800a. The three terminals are separated by and electrically insulated by posts 804a, the posts supporting the movable layer 806a between the electrodes 802a, 810a. At least a portion of the movable layer 806a is configured to move in the cavity (or space) between the upper electrode 802a and the lower electrode 810a.

In FIG. 9A, the movable layer 806a is shown in an equilibrium (e.g., unactuated) position where the movable layer is substantially flat and/or substantially parallel with the upper and lower electrodes 802a, 810a. In this state the movable layer 806a is not being driven by applied voltages, or any applied voltages result in offsetting electrostatic forces so the movable layer 806a is not driven towards either electrode 802a, 810a.

The movable layer 806a can be driven between the upper and lower electrodes 802a, 810a using various circuit configurations. As illustrated in FIG. 9A, the modulator 800a includes a first control circuit 850a and a second control circuit 852a. The first control circuit 850a can be configured to apply a voltage across the upper electrode 802a and the movable layer 806a. The resulting potential creates an electric field between the movable layer 806a and the upper electrode 802a, producing an electrostatic force which actuates the movable layer 806a. When the movable layer 806a is electrostatically actuated in this way, it moves towards the upper electrode 802a. The movable layer 806a can be moved to various positions between the relaxed position (e.g., the unactuated position) and the upper electrode 802a by varying the voltage applied by the control circuit 850a.

Still referring to FIG. 9A, as the movable layer 806a moves away from this equilibrium position (e.g., toward the upper electrode 802a or lower electrode 810a), the side portions of the movable layer 806a can deform or bend and provide an elastic spring force that serves as a restoration force on the movable layer to try and move the movable layer 806a back to the equilibrium position. In some implementations, the modulator 800a is configured as an interferometric modulator and the movable electrode 806a serves as a mirror that reflects light entering the structure through a substrate layer 812a. In one implementation, the substrate 812a is made of glass, but the substrate 812a can be formed of other materials, for example, plastics. In one implementation, the upper electrode 802a includes an absorber layer (e.g., a partially transmissive and partially reflective layer) made from, for example, chromium. In some implementations, a dielectric stack (e.g., two layers of dielectric materials having different indexes of refraction) can be disposed between the movable layer 806a and the electrode 802a to selectively filter light entering the modulator 800a through the substrate 812a. In implementations where the modulator 800a is configured to selectively reflect light, an interferometric cavity 840a can be disposed between the electrode 802a and the movable layer 806a. The height of the interferometric cavity 840a (e.g., the distance between the electrode 802a and the movable layer 806a changes as the movable layer 806a moves between the upper electrode 802a and the lower electrode 810a.

Still referring to FIG. 9A, the second control circuit 852a is configured to apply a voltage across the lower electrode 810a and the movable layer 806a. In implementations where the movable layer 806a includes a reflective layer and a conductive layer, the voltage can be applied to the movable layer 806a at the reflective layer or the conductive layer. Applying the voltage creates an electric field between the movable layer 806a and the lower electrode 810a, producing an electrostatic force which actuates the movable layer 806a. When the movable layer 806a is electrostatically actuated by the second control circuit 852a, it moves towards the lower electrode 810a. Applying more voltage generates stronger electrostatic forces which move the movable layer 806a closer to the lower electrode 810a. Thus, the movable layer 806a can be moved to various positions between the relaxed position and the lower electrode 810a by varying the voltage applied by the control circuit 852a.

In some implementations, the first and second control circuits 850a, 852a can be configured to apply voltages simultaneously or separately to control the movement of the movable layer 806a. For example, the first control circuit 850a can apply a first voltage across the upper electrode 802a and the movable layer 806a and the second control circuit 852a can simultaneously apply a second voltage across the lower electrode 810a and the movable layer 806a. In such an example, movement of the movable layer 806a will be determined by the magnitude of the two voltages applied by the first and second control circuits 850a, 852a. In other implementations, the first and second control circuits 850a, 852a do not apply voltages simultaneously to the movable layer 806a.

FIG. 9B shows an example of a cross-section of a three-terminal interferometric modulator which is charge driven and in which the movable layer is shown in a relaxed position. Modulator 800b includes an upper electrode 802b, a lower electrode 810b, and a movable layer 806b disposed therebetween. The modulator 800b can further include posts 804b that insulate terminals 802b, 810b, and 806b from other structures and position the movable layer 806b between the electrodes 802b, 810b, for example a distance indicated by 840b from the upper electrode 802b.

A control circuit 850b is configured to apply a voltage across the upper electrode 802b and the lower electrode 810b. A second control circuit 852b is configured to selectively apply an amount of charge to the movable layer 806b. In some implementations second control circuit 852b includes charge pump or a current source that is turned on for a specific amount of time. In some implementations, second control circuit 852b can use one or more switching devices to control the connection of voltages to a capacitor. In one implementation, the second control circuit 852b can be configured to apply a charge between about 1 pC to about 20 pC to the movable layer 806b, however, other charges also can be applied. Using the control circuits 850b, 852b, electrostatic actuation of the movable layer 806b is achieved. When connected, i.e., when switch 833b contacts the movable layer 806b, the second control circuit 852b delivers an amount of positive charge to the movable layer 806b . The charged movable layer 806b then, interacts with the electric field created by the application of a voltage by control circuit 850b between upper electrode 802b and lower electrode 810b. The interaction of the charged movable layer 806b and the electric field causes the movable layer 806b to move between electrodes 802b, 810b. The movable layer 806b can be moved to various positions by varying the voltage applied by the control circuit 850b. For example, a voltage V_{c} (“positive” as indicated in FIG. 9B on the lower electrode 810b) applied by control circuit 850b causes the lower electrode 810b to achieve a positive potential with respect to the upper electrode 802b, such that the lower electrode 810b repels the positively charged movable layer 806b. Accordingly, the illustrated voltage V_{c} causes movable layer 806b to move toward the upper electrode 802b. Assuming the movable layer 806b is positively charged, application of voltage V_{c} by control circuit 850b causes the lower electrode 810b to be driven to a negative potential with respect to the upper electrode 802b and attracts movable layer 806b toward the lower electrode 810b. In this way, the movable layer 806b can move to a wide range of positions between the electrodes 802b, 810b.

A switch 833b can be used to selectively connect or disconnect the movable layer 806b from the second control circuit 852b. Those having ordinary skill in the art will understand that other methods known in the art besides a switch 833b may be used to selectively connect or disconnect the movable layer 806b from the second control circuit 852b. For example, a thin film semiconductor, a fuse, or an anti fuse, also can be used.

The switch 833b can be configured to open and close to deliver a specific amount of charge to the movable layer 806b by a control circuit (not shown). The charge level can be chosen based on the desired electrostatic force. Further, the control circuit can be configured to reapply a charge over time as an applied charge may leak away or dissipate from the movable layer 806b. In some implementations, a charge can be reapplied to the movable layer 806b according to a specified time interval. In one implementation, the specific time interval ranges between about 10 ms and about 100 ms.

FIG. 9C shows an example of a diagram illustrating a simulation of the deflection of a movable layer as the charge applied on the movable layer is changed by different voltages applied by a control circuit. Curve 871 represents the simulated deflection of a movable layer in one implementation of an interferometric modulator as the charge applied to the movable layer varies when a voltage of about 29.49 V is applied by a control circuit. As can be seen by following curve 871 from 0.0 (zero) charge and 0.0 (zero) deflection to the right, applying a positive charge causes the movable layer to deflect in a positive relative direction. Also, following curve 871 from 0.0 (zero) charge and 0.0 (zero) deflection to the left demonstrates that applying a negative charge causes the movable layer to deflect in a negative relative direction. Curve 873 represents the simulated deflection of a movable layer in one implementation of an interferometric modulator as the charge applied to the movable layer varies when a voltage of about 22.50 V is applied by a control circuit. Curve 875 represents the simulated deflection of a movable layer in one implementation of an interferometric modulator as the charge applied to the movable layer varies when a voltage of about 15.51 V is applied by a control circuit. Curve 877 represents the simulated deflection of a movable layer in one implementation of an interferometric modulator as the charge applied to the movable layer varies when a voltage of about 8.52 V is applied by a control circuit. Curve 879 represents the simulated deflection of a movable layer in one implementation of an interferometric modulator as the charge applied to the movable layer varies when a voltage of about 1.53 V is applied by a control circuit. Curve 881 represents the simulated deflection of a movable layer in one implementation of an interferometric modulator as the charge applied to the movable layer varies when a voltage of about −5.46 V is applied by a control circuit. Curve 883 represents the simulated deflection of a movable layer in one implementation of an interferometric modulator as the charge applied to the movable layer varies when a voltage of about −12.45 V is applied by a control circuit. Curve 885 represents the simulated deflection of a movable layer in one implementation of an interferometric modulator as the charge applied to the movable layer varies when a voltage of about −19.44 V is applied by a control circuit. Curve 887 represents the simulated deflection of a movable layer in one implementation of an interferometric modulator as the charge applied to the movable layer varies when a voltage of about −26.43 V is applied by a control circuit. Curve 889 represents the simulated deflection of a movable layer in one implementation of an interferometric modulator as the charge applied to the movable layer varies when a voltage of about −33.42 V is applied by a control circuit. Curve 891 represents the simulated deflection of a movable layer in one implementation of an interferometric modulator as the charge applied to the movable layer varies when a voltage of about −40.42 V is applied by a control circuit.

FIG. 9D shows an example of a cross-section of a three-terminal interferometric modulator configured to drive a movable layer through a range of states (or positions). As illustrated, the movable layer 906 can be moved to various positions 930-936 between the upper electrode 902 and the lower electrode 910. In one implementation, the movable layer 906 can be moved according to the methods, and using structures, described with respect to FIG. 9A. In another implementation, the movable layer 906 can be moved according to the methods, and using the structures, described with respect to FIG. 9B.

The modulator 900 can selectively reflect certain wavelengths of light depending on the configuration of the modulator. In some implementations, the distance between the upper electrode 902 and the movable layer 906 changes the interferometric properties of the modulator 900. In some implementations, the upper electrode 902 can act as, or include, an absorbing layer. For example, the modulator 900 can be configured to be viewed through the substrate 912 side of the modulator. In this example, light enters the modulator 900 through the substrate 912. Depending on the position of the movable layer 906, different wavelengths of light are reflected from the movable layer 906 back through the substrate 912, which gives the appearance of different colors. For example, in position 930, a red (R) wavelength of light is reflected while other colors are absorbed. Accordingly, the interferometric modulator 900 can be considered in a red state when the movable layer 906 is in position 930. When the movable layer 906 moves to position 932, the modulator 900 is in a green state and green (G) light is reflected through the substrate 912. When the movable layer 906 moves to position 934, the modulator 900 is in a blue state and blue (B) light is reflected, and when the movable layer 906 moves to position 936, the modulator is in a white state and all the wavelengths of light in the visible spectrum are reflected (e.g., a white (W) color is reflected). In one implementation, when the movable layer 906 is in the white state the distance between the movable layer and the upper electrode 902 is very small, for example, approximately less than about 10 nm, in some implementations about 0-5 nm, and in other implementations about 0-1 nm. In one implementation, when the movable layer 906 is in the red state the distance between the movable layer and the upper electrode 902 is about 350 nm. In one implementation, when the movable layer 906 is in the green state the distance between the movable layer and the upper electrode 902 is about 250 nm. In one implementation, when the movable layer 906 is in the blue state the distance between the movable layer and the upper electrode 902 is about 200 nm. In one implementation, when the movable layer 906 is in the black state the distance between the movable layer and the upper electrode 902 is about 100 nm. One having ordinary skill in the art will recognize that the modulator 900 can take on other states and selectively reflect other wavelengths of light or combinations of wavelengths of light depending on the materials used in the construction of the modulator 900 and on the position of the movable layer 906. Therefore, in some implementations, it is desirable to maximize the distance through which the movable layer 906 can move while maintaining the stability of the modulator 900.

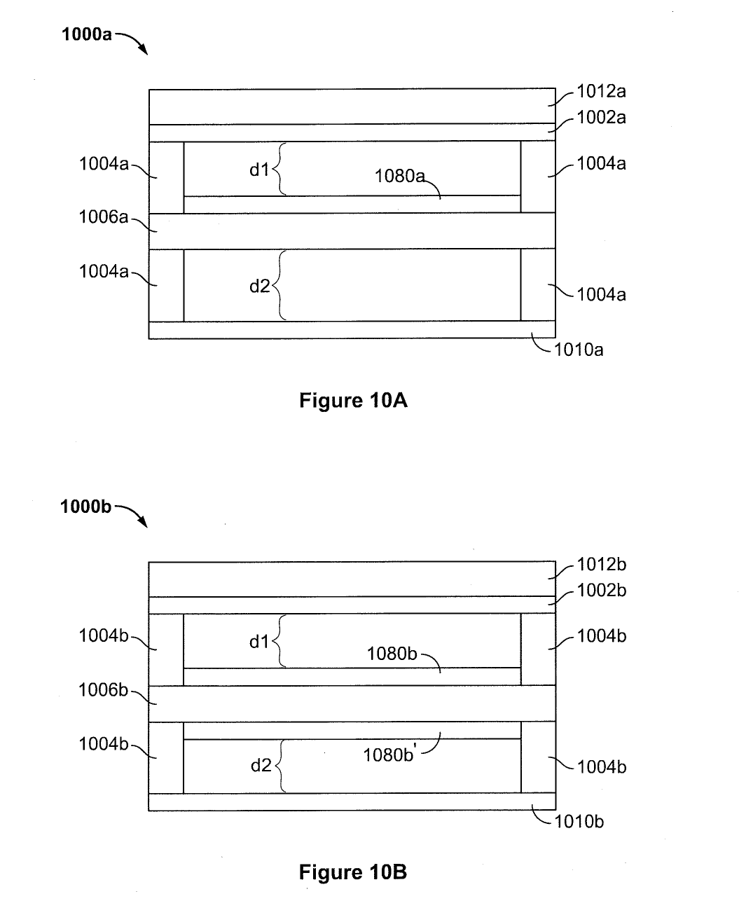

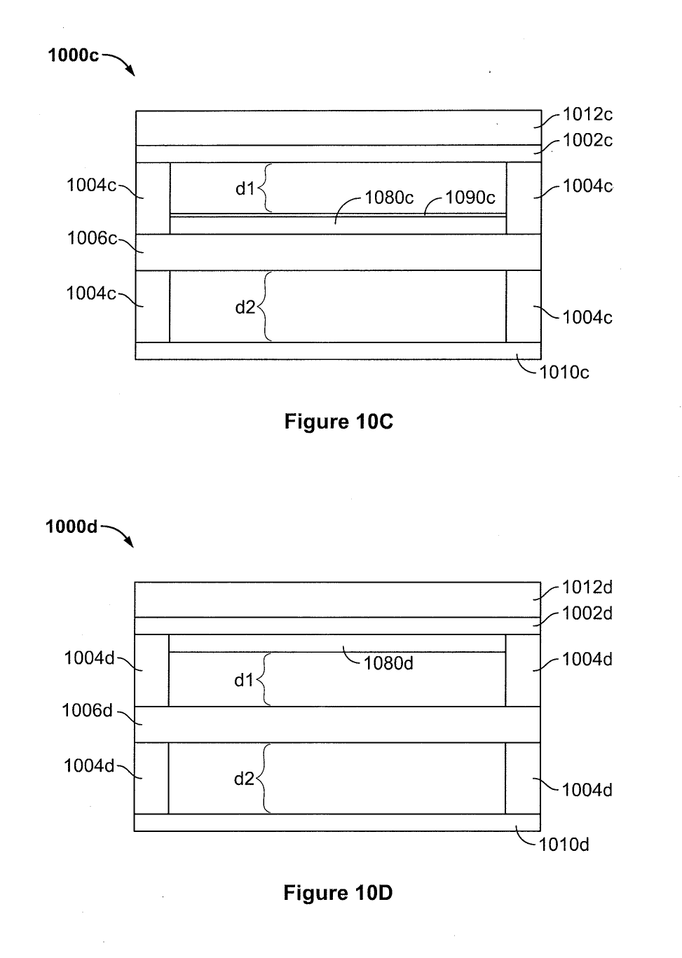

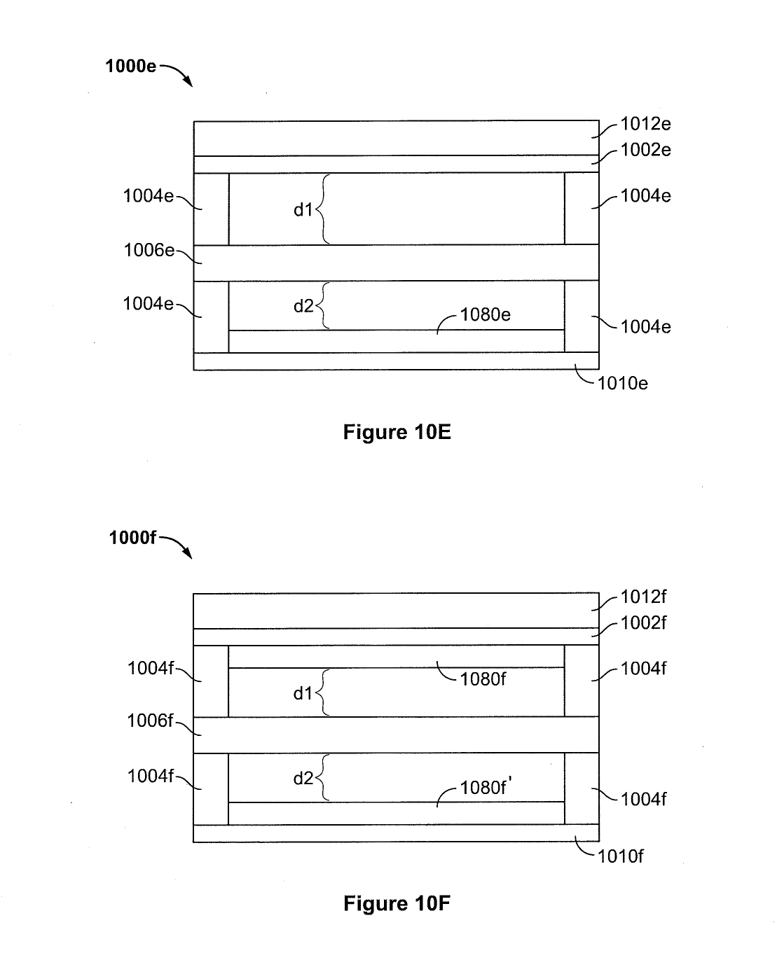

FIG. 10A shows an example of a cross-section of a three-terminal interferometric modulator with a capacitance control layer disposed on the movable layer between the movable layer and the upper electrode. The interferometric modulator 1000a configured such that the movable layer 1006a is electrostatically driven between the upper electrode 1002a and the lower electrode 1010a. In some implementations, the movable layer 1006a serves as a mirror that reflects light entering the structure through a substrate layer 1012a. In some implementations, the electric field induced by a voltage applied between the upper electrode 1002a and the movable layer 1006a can be defined as follows:

E=V/(δ₁) (1)

where:

E is the electric field due to a voltage V applied by a control circuit; and

δ₁ is the effective distance between the upper electrode 1002a and the movable layer 1006a.

Similarly, the electric field induced by a voltage applied between the lower electrode 1010a and the movable layer 1006a can be defined as follows:

E=V/(δ₂) (2)

where:

E is the electric field due to voltage V applied by a control circuit; and

δ₂ is the effective distance between the lower electrode 1010a and the movable layer 1006a.

Effective distance takes into account both the actual distance (e.g., d₁ and d₂) between the two electrodes and the effect of the capacitance control layer 1080a. Therefore, δ₁=d₁+d_{ε}/ε and δ₂=d₂+d_{ε}/ε. In the illustrated implementation, δ₂=d₂ because there is not a capacitance control layer disposed between the movable layer 1006a and the lower electrode 1010a. In some implementations, the capacitance control layer 1080a works to increase the effective distance and the effective distance of the capacitance control layer itself is calculated as d_{ε}/ε where d_{ε} is the thickness of the capacitance control layer and ε is the dielectric constant of the capacitance control layer 1080a. When materials with high dielectric constants are placed in an electric field, the magnitude of that electric field will be measurably reduced within the volume of the dielectric material. On the other hand, the capacitance control layer 1080a increases the effective distance between the upper electrode 1002a and the movable layer 1006a by decreasing the electric field and electrostatic force between the electrode 1002a and the movable layer 1006a. Capacitance control layers can have different thicknesses and can be formed of various materials. For example, capacitance control layers can have thicknesses between about 100 nm and 3000 nm. In some implementations, capacitance control layers can include dielectric materials, for example, silicon oxy-nitride having a dielectric constant of about 5 or silicon dioxide having a dielectric constant of about 4. The capacitance control layers can be formed of a single layer of material or a composite stack of materials.

Still referring to FIG. 10A, instability in the modulator 1000a can occur if an electrostatic force acting on the movable layer 1006a is greater than a mechanical restoration force of the movable layer 1006a. When this occurs, the movable layer 1006a can move rapidly (or “snap”) towards the activating electrode and this movement can affect the optical interference characteristics of the modulator 1000a. The mechanical restoration force F_{S} can be defined as:

F_{S}=−Kx (3)

where:

K=the composite spring constant of the movable layer; and

x=the position of the movable layer 1006a relative to the equilibrium or relaxed position of the movable layer 1006a when no voltage is applied by a control circuit.

Thus, the point of instability for the modulator 1000a can be determined by balancing the mechanical restoration force of the movable layer 1006a with the electrostatic forces applied to the movable layer. The electrostatic forces acting on the movable layer 1006a are related to electric fields between the upper electrode 1002a and the movable layer 1006a and between the lower electrode 1010a and the movable layer 1006a. Accordingly, the overall distance the movable layer 1006a can move between the upper electrode 1002a and the lower electrode 1010a while remaining stable can be determined by calculating the range of x where the mechanical restoration force of the movable layer 1006a is greater than the electrostatic forces applied to the movable layer. This distance or stable range of movement can be increased by increasing the effective distances between the electrodes and the movable layer 1006a.

Still referring to FIG. 10A, in one example, the capacitance control layer 1080a includes silicon oxy-nitride and has a thickness of about 150 nm, the distance (d1) between the capacitance control layer 1080a when the movable layer 1006a is relaxed and the upper electrode 1002a is about 329 nm, and the distance (d2) between the movable layer 1006a when the movable layer is relaxed and the bottom electrode 1010a is about 300 nm. In this exemplary configuration, the movable layer 1006a can move stably through up to about 83% of d1 while the stable movement through d2 is limited to about 74% of the total distance, using control mechanism 850b shown in FIG. 9B. The increased range of stable motion toward the upper electrode 1002a is attributable to the increase of effective distance between the movable layer 1006a and upper electrode 1002a due to the capacitance control layer 1080a. The increased range of stable motion through d1 also increases the range of stable motion of the modulator 1000a as a whole. In this particular example, the movable layer 1006a can stably move through about 79% of the total sum of d1 and d2.

FIG. 10B shows an example of a cross-section of a three-terminal interferometric modulator with a first capacitance control layer disposed on the movable layer between the movable layer and the upper electrode and a second capacitance control layer disposed on the movable layer between the movable layer and the lower electrode. The second capacitance control layer 1080b′ can be configured to increase the stable range of motion between the movable layer and the bottom electrode 1010b as described above to increase the overall range of optical states of the modulator 1000b. In one example, the first capacitance control layer 1080b includes silicon oxy-nitride and has a thickness of about 150 nm, the distance (d1) between the first capacitance control layer 1080b when the movable layer 1006b is relaxed and the upper electrode 1002b is about 450 nm, and the distance (d2) between the second capacitance control layer 1080b′ when the movable layer is relaxed and the bottom electrode 1010b is about 150 nm. In this exemplary configuration, the movable layer 1006b can move stably through up to about 82% of d1 and through up to about 98% of d2. The total range the movable layer 1006b can move through in this example is about 91% of the total sum of d1 and d2 due to the presence of the capacitance control layers.

FIG. 10C shows an example of a cross-section of the interferometric modulator of FIG. 10A with a protective layer disposed on the capacitance control layer. The protective layer 1090c can be configured to protect the capacitance control layer 1080c from being etched during certain methods of manufacturing of the modulator 1000c. In some implementations, the protective layer 1090c has a thickness ranging from about 5 nm to about 500 nm. In one example, the protective layer 1090c is about 16 nm thick. The protective layer 1090c can be formed of materials that are resistant to etchants, for example, XeF₂. In some implementations, the protective layer 1090c includes aluminum oxide or titanium dioxide.

Still referring to FIG. 10C, in one example, the capacitance control layer 1080c includes silicon oxy-nitride and has a thickness of about 150 nm. The distance (d1) between the protective layer 1090c (when the movable layer 1006c is unactuated or relaxed) and the upper electrode 1002c is about 540 nm. The distance (d2) between the conductive movable layer 1006c when the movable layer is relaxed and the bottom electrode 1010c is about 300 nm. In this exemplary configuration, the movable layer 1006c can move stably through up to about 83% of the distance d1 while the stable movement through d2 is about 79% of the distance d2. Accordingly, the total range the movable layer 1006c can move through in this example is about 81% of the sum of distances d1 and d2.

In FIGS. 10D-10F, modulators 1000d-f are illustrated with one or more capacitance control layers 1080, 1080d disposed on the upper electrode 1002d (FIG. 10D), lower electrode 1010e (FIG. 10E), or both the upper and lower electrodes (FIG. 10F). Specifically, FIG. 10D shows an example of a cross-section of a three-terminal interferometric modulator with a capacitance control layer disposed on the upper electrode between the movable layer and the upper electrode. The capacitance control layer 1080d is configured to decrease the electrostatic force between the upper electrode 1002d and the movable layer 1006d which increases the stable range of motion through which the movable layer 1006d can move relative to the upper electrode 1002d. FIG. 10E shows an example of a cross-section of a three-terminal interferometric modulator with a capacitance control layer disposed on the lower electrode between the movable layer and the lower electrode. The capacitance control layer 1080e is configured to decrease the electrostatic force between the lower electrode 1010e and the movable layer 1006e which increases the stable range of motion through which the movable layer 1006e can move relative to the lower electrode 1010e. FIG. 10F shows an example of a cross-section of a three-terminal interferometric modulator with a first capacitance control layer disposed on the upper electrode between the movable layer and the upper electrode and a second capacitance control layer disposed on the lower electrode between the movable layer and the lower electrode. The first and second capacitance control layers 1080f, 1080f decreases the electrostatic forces between the electrodes 1002d, 1010f and the movable layer 1006f, which increases the stable range of motion of the movable layer 1006f relative to the top and bottom electrodes. In one implementation, the first and second capacitance control layers 1080f, 1080f′ have thickness dimensions that range between about 1 micron and about 3 microns.

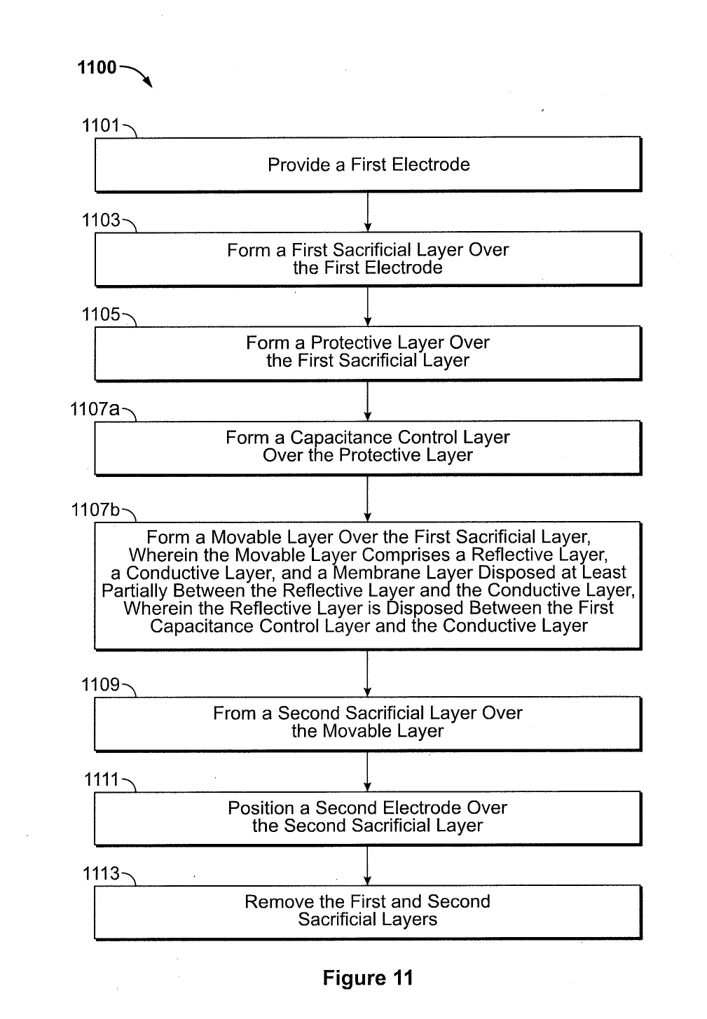

FIG. 11 shows an example of a flow diagram illustrating a method of making an interferometric display. While particular parts and blocks are described as suitable for interferometric modulator implementation, it will be understood that for other electromechanical system implementations, different materials can be used and blocks omitted, modified, or added.

Method 1100 includes the block of providing a first electrode as illustrated in block 1101. As described above with reference to FIG. 1, in some implementations the first electrode can include an optical stack having several layers, for example, an optical transparent conductor, such as indium tin oxide (ITO), a partially reflective optical absorber, such as chromium, and a transparent dielectric. In one implementation, the first electrode includes a MoCr layer having a thickness in the range of about 30-80 Å, an AlOₓ layer having a thickness in the range of about 50-150 Å, and a SiO₂ layer having of thickness in the range of about 250-500 Å. The absorber layer can be formed from a variety of materials that are partially reflective such as various metals, semiconductors, and dielectrics. The partially reflective layer can be formed of one or more layers, and each of the layers can be formed of a single material or a combination of materials. In some implementations, the layers of the first electrode are patterned into parallel strips, and may form row/column electrodes in a display device as described above with reference to FIG. 1.

Method 1100 further includes the block of forming a first sacrificial layer over the first electrode as illustrated in block 1103. The first sacrificial layer is later removed as discussed below to form a gap or space between the first electrode and the capacitance control layer. The formation of the first sacrificial layer over the first electrode can include a deposition block. Additionally, the first sacrificial layer can include more than one layer, or include a layer of varying thickness, to aid in the formation of a display device having a multitude of resonant optical gaps. For an interferometric modulator array, each gap size can represent a different reflected color. In some implementations, the sacrificial layer may be patterned to form vias so as to aid in the formation of support posts.

Method 1100 also can optionally include forming a protective layer over the first sacrificial layer as illustrated in block 1105 and forming a capacitance control layer over the protective layer as illustrated in block 1107a. A movable layer can be formed over the first sacrificial layer. As discussed above, in some implementations, the movable layer can include a single optically reflective and electrically conductive layer and in other implementations, the movable layer includes a reflective layer, a conductive layer, and a membrane layer disposed at least partially between the reflective layer and the conductive layer. The reflective layer is disposed between the first capacitance control layer and the conductive layer as illustrated in block 1107b. In one implementation, the membrane layer is a dielectric layer, for example, SiON. The reflective layer and the conductive layer can include various materials, for example, metals.

As illustrated in block 1109, the method 1100 can further include forming a second sacrificial layer over the movable layer. The second sacrificial layer is typically later removed to form a gap or space between the movable layer and the second electrode. The formation of the second sacrificial layer over the movable layer can include a deposition block. Additionally, the second sacrificial layer can be selected to include more than one layer, or include a layer of varying thickness, to aid in the formation of a display device having a multitude of resonant optical gaps. A second electrode can be positioned over the second sacrificial layer as illustrated in block 1111. Lastly, the method 1100 can include removing the first and second sacrificial layers as illustrated in block 1113. The sacrificial layers can be removed using a variety of methods, for example, using an XeF₂ dry etch process. After removal, the movable layer can move through the cavities and deflect towards the first electrode and/or second electrode. A person having ordinary skill in the art will understand that additional blocks may be included in a method of manufacturing an interferometric modulator and that blocks may be altered or added in order to make any of the implementations illustrated in FIGS. 10A-10F.

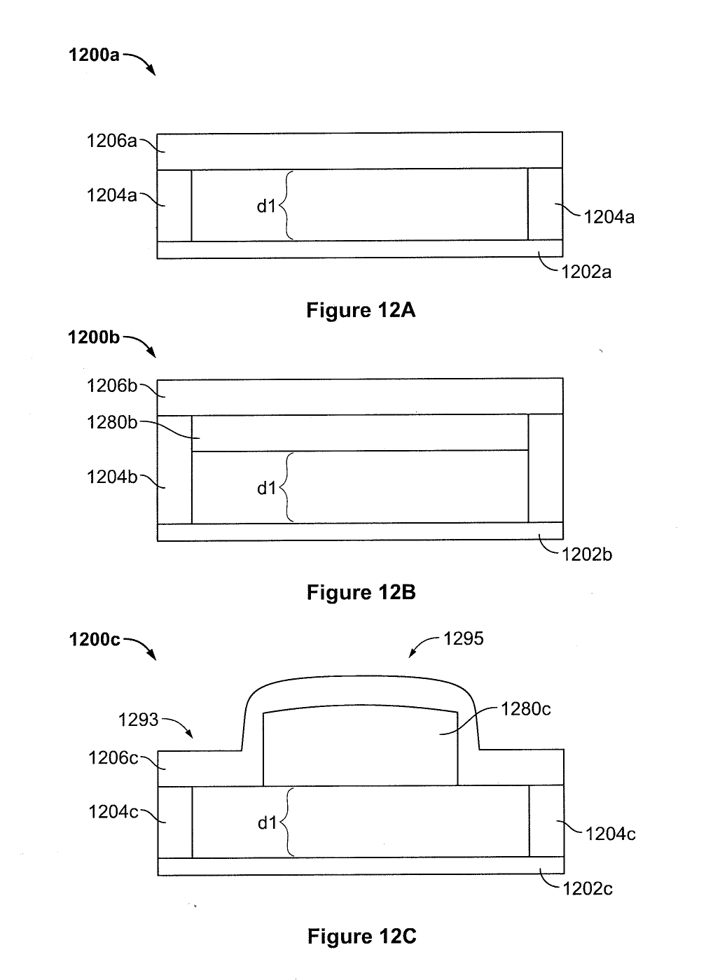

As discussed above, analog interferometric modulators can include three-terminal configurations. FIG. 12A shows an example of a cross-section of a two-terminal interferometric modulator in which the movable layer is in a relaxed position. The interferometric modulator 1200a includes an electrode 1202a and a movable layer 1206a spaced apart from the electrode 1202a by insulating posts 1204a. In this configuration, the movable layer 1206a and the electrode 1202a can each be considered a terminal. The movable layer 1206a can optionally include a reflective layer, a conductive layer, and a membrane layer disposed therebetween. The movable layer 1206a can be electrostatically actuated to move toward the electrode 1202a to change the reflectance of light that is incident on the electrode 1202a side of the modulator 1200a. As with the three-terminal modulators discussed above, the stable range of movement of the movable layer 1206a is determined by the balancing of the mechanical restoration forces of the movable layer with the magnitude of the electrostatic forces that move the movable layer 1206a toward the electrode 1202a. In one example, the distance d1 between the movable layer 1206a and the electrode 1202a when the movable layer is relaxed or unactuated is 500 nm and the stable range of motion of the movable layer is about 59.5% of the distance d1. As with three-terminal configurations, the stable range of motion of a movable layer in a two-terminal configuration can be increased by adding a capacitance control layer between the movable layer and the electrode.

FIG. 12B shows an example of a cross-section of a two-terminal interferometric modulator in which is a capacitance control layers is disposed on the movable layer between the electrode and the movable layer. The capacitance control layer 1280b is disposed on the movable layer 1206b between the movable layer 1206b and an electrode 1202b. Thus, the capacitance control layer 1280b reduces the magnitude of an electrostatic force between the electrode 1202b and the movable layer 1206b which allows the movable layer 1206b to move stably through a larger range of d1 than the movable layer 1206b would be able to move through without the capacitance control layer 1280b.

FIG. 12C shows an example of a cross-section of a two-terminal interferometric modulator in which the movable layer includes a first portion and a second portion that is offset from the first portion and in which a capacitance control layer is disposed on the second portion of the movable layer between the electrode and the movable layer. In the illustrated implementation, the movable layer 1206c includes a first portion 1293 and a second portion 1295 that is offset from the first portion such that the first portion 1293 is disposed at least partially between the second portion 1295 and the electrode 1202c. The capacitance control layer 1280c is disposed on the second portion 1295 and increases the effective electrical distance between the second portion and the electrode 1202c. Thus, the capacitance control layer 1280c reduces the magnitude of an electrostatic force between the electrode 1202c and the second portion 1295 which allows the second portion 1295 to move stably through a larger range of d1 than the second portion 1295 would be able to stably move without the capacitance control layer 1280c. In one example, the distance (d1) between the capacitance control layer 1280c and the electrode 1202c is about 300 nm to about 800 nm, the capacitance control layer 1280 includes a 150 nm thick layer of silicon oxy-nitride, and the second portion 1295 can move stably through about 80% of d1 toward the electrode 1202b. Accordingly, capacitance control layers can increase the stability and versatility of two-terminal analog interferometric modulators and three-terminal analog interferometric modulators.

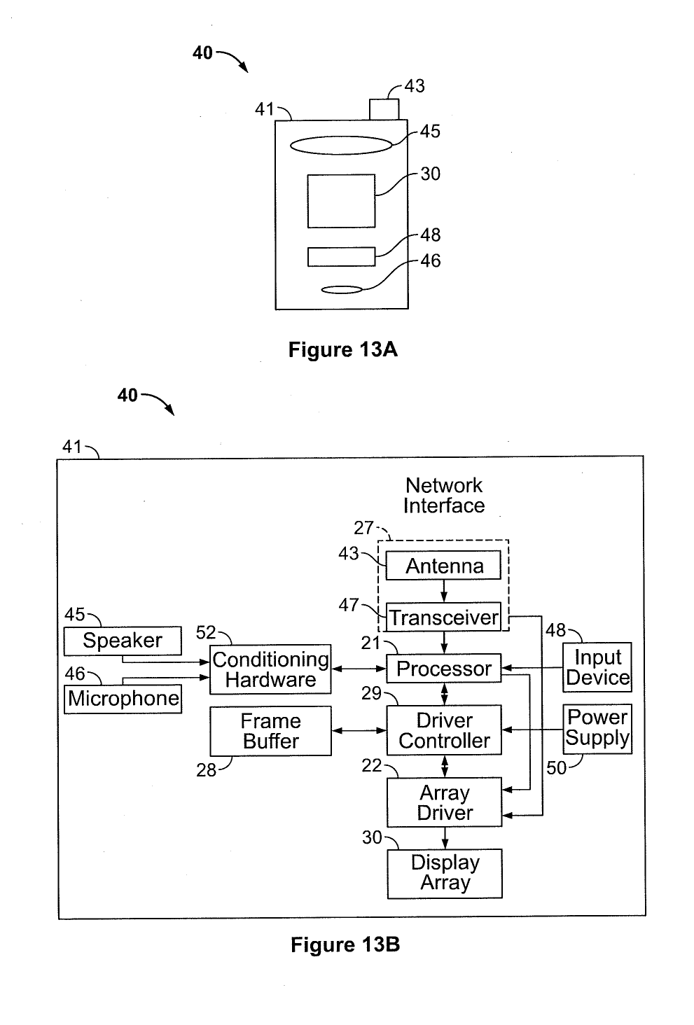

FIGS. 13A and 13B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a first electrode;
a movable layer, at least a portion of the movable layer being configured to move toward the first electrode when a first voltage is applied across the first electrode and the movable layer;
an interferometric cavity disposed between the movable layer and the first electrode; and
a first capacitance control layer disposed on a portion of the movable layer, the first capacitance control layer being positioned at least partially between the first electrode and the movable layer, the first capacitance control layer being at least partially transmissive.

2. The display device of claim 1, wherein the capacitance control layer is configured to decrease the magnitude of a first electric field between the movable layer and the first electrode when the first voltage is applied across the movable layer and the first electrode.

3. The display device of claim 1, wherein the first electrode includes a conductive layer and an absorber layer, the absorber layer being at least partially transmissive.

4. The display device of claim 1, further comprising a first protective layer disposed on the first capacitance control layer, wherein at least a portion of the first protective layer is disposed at least partially between the first capacitance control layer and the first electrode.

5. The display device of claim 4, wherein the first protective layer includes one of aluminum oxide or titanium dioxide.

6. The display device of claim 5, wherein the first protective layer has a thickness dimension that is between about 5 nm and about 500 nm.

7. The display device of claim 1, further comprising a second electrode, wherein a portion of the movable layer is disposed between the first electrode and the second electrode.

8. The display device of claim 7, wherein the movable layer is configured to move toward the second electrode when a second voltage is applied between the second electrode and the movable layer.

9. The display device of claim 8, further comprising a second capacitance control layer disposed on a portion of the movable layer, the second capacitance control layer being positioned at least partially between the second electrode and the movable layer.

10. The display device of claim 9, wherein the second capacitance control layer is configured to decrease the magnitude of a second electric field between the movable layer and the second electrode when the second voltage is applied across the movable layer and the second electrode.

11. The display device of claim 9, further comprising a control circuit configured to apply the first and second voltages.

12. The display device of claim 9, wherein the second capacitance control layer includes one of silicon dioxide or silicon oxy-nitride.

13. The display device of claim 9, wherein the second capacitance control layer has a thickness dimension that is between about 100 nm and about 4000 nm.

14. The display device of claim 9, further comprising a second protective layer disposed on the second capacitance control layer, wherein a portion of the second protective layer is disposed at least partially between the second capacitance control layer and the second electrode.

15. The display device of claim 14, wherein the second protective layer includes one of aluminum oxide or titanium dioxide.

16. The display device of claim 14, wherein the second protective layer has a thickness dimension that is between about 5 nm and about 500 nm.

17. The display device of claim 1, wherein the first capacitance control layer includes a dielectric material.

18. The display device of claim 17, wherein the first capacitance control layer includes one of silicon dioxide or silicon oxy-nitride.

19. The display device of claim 18, wherein the first capacitance control layer has a thickness dimension that is between about 100 nm and about 4000 nm.

20. The display device of claim 19, wherein the first capacitance control layer has a thickness dimension that is about 150 nm and the first capacitance control layer and the first electrode define an air gap therebetween, the air gap having a dimension that is between about 300 nm and about 700 nm.

21. The display device of claim 1, further comprising:
a display;
a processor that is configured to communicate with the display, the processor being configured to process image data; and
a memory device that is configured to communicate with the processor.

22. The display device of claim 21, further comprising a driver circuit configured to send at least one signal to the display.

23. The display device of claim 22, further comprising a controller configured to send at least a portion of the image data to the driver circuit.

24. The display device of claim 21, further comprising an image source module configured to send the image data to the processor.

25. The display device of claim 24, wherein the image source module includes at least one of a receiver, transceiver, and transmitter.

26. The display device of claim 21, further comprising an input device configured to receive input data and to communicate the input data to the processor.

27. A display device comprising:
a first electrode;
means for interferometrically modulating light, at least a portion of the modulating means being configured to move toward the first electrode when a voltage is applied across the first electrode and the modulating means, wherein an interferometric cavity is disposed between the modulating means and the first electrode; and
control means for decreasing the magnitude of an electric field between the electrode and the modulating means when the voltage is applied across the modulating means and the electrode, the control means being disposed on a portion of the modulating means, the control means being positioned at least partially between the electrode and the modulating means, the control means being at least partially transmissive.

28. The display device of claim 27, wherein the electrode includes means for absorbing light that is at least partially transmissive.

29. The display device of claim 27, wherein the control means includes a dielectric material.

30. The display device of claim 27, further comprising a second electrode, wherein a portion of the modulating means is disposed between the first electrode and the second electrode.

31. The display device of claim 27, further comprising a first protective layer disposed on the control means, wherein at least a portion of the first protective layer is disposed at least partially between the control layer and the first electrode.

32. The display device of claim 27, further comprising:
a display;
a processor that is configured to communicate with the display, the processor being configured to process image data; and
a memory device that is configured to communicate with the processor.

33. A display device comprising:
a first electrode;
an absorber layer disposed at least partially on the first electrode, the absorber layer being at least partially transmissive;
a movable layer disposed such that at least a portion of the absorber layer is positioned between at least a portion of the movable layer and at least a portion of the first electrode, wherein at least a portion of the movable layer is configured to move toward the first electrode when a first voltage is applied across the first electrode and the movable layer;
an interferometric cavity defined between the movable layer and the absorber layer; and
a first capacitance control layer disposed on a portion of the absorber layer, the first capacitance control layer being positioned at least partially between the absorber layer and the movable layer, the first capacitance control layer being at least partially transmissive.

34. The display device of claim 33, wherein the first capacitance control layer is configured to decrease the magnitude of a first electric field between the movable layer and the first electrode when the first voltage is applied across the movable layer and the first electrode.

35. The display device of claim 33, further comprising a second electrode, wherein a portion of the movable layer is disposed between the first electrode and the second electrode.

36. The display device of claim 35, wherein the movable layer is configured to move toward the second electrode when a second voltage is applied between the second electrode and the movable layer.

37. The display device of claim 36, further comprising a second capacitance control layer disposed on a portion of the second electrode, the second capacitance control layer being positioned at least partially between the second electrode and the movable layer.

38. The display device of claim 37, wherein the second capacitance control layer is configured to decrease the magnitude of a second electric field between the movable layer and the second electrode when the voltage is applied across the movable layer and the second electrode.

39. The display device of claim 33, further comprising a first protective layer disposed on the first capacitance control layer, wherein at least a portion of the first protective layer is disposed at least partially between the first capacitance control layer and the movable layer.

40. A display device comprising:
an electrode;
a movable layer, at least a portion of the movable layer being configured to move toward the electrode when a voltage is applied across the first electrode and the movable layer, wherein an interferometric cavity is defined between the movable layer and the first electrode, wherein the movable layer includes a first portion and a second portion, and wherein the second portion is offset from the first portion; and
a capacitance control layer configured to decrease the magnitude of an electric field between the movable layer and the electrode when the voltage is applied across the movable layer and the electrode, the capacitance control layer being disposed on the second portion of the movable layer, the capacitance control layer being positioned at least partially between the electrode and the movable layer.

41. The display device of claim 40, wherein the movable layer includes a step between the first portion and the second portion.

42. The display device of claim 40, wherein the capacitance control layer includes a dielectric material.

43. The display device of claim 42, wherein the capacitance control layer is at least partially transmissive.

44. The display device of claim 40, further comprising an absorber layer disposed at least partially on the electrode, the absorber layer disposed at least partially between the electrode and the capacitance control layer.

45. The display device of claim 40, further comprising a protective layer disposed on the capacitance control layer, wherein at least a portion of the first protective layer is disposed at least partially between the capacitance control layer and the electrode.

46. The display device of claim 40, wherein the first protective layer includes one of aluminum oxide or titanium dioxide.

47. The display device of claim 40, further comprising:
a display;
a processor that is configured to communicate with the display, the processor being configured to process image data; and
a memory device that is configured to communicate with the processor.

48. A method of manufacturing a display device, the method comprising:
providing a first electrode;
forming a first sacrificial layer over the first electrode;
forming a first capacitance control layer over the first sacrificial layer; and
forming a movable layer over the first sacrificial layer.

49. The method of claim 48, further comprising forming a first protective layer between the first sacrificial layer and the first capacitance control layer.

50. The method of claim 48, further comprising:
forming a second sacrificial layer over the movable layer;
positioning a second electrode over the second sacrificial layer; and
removing the first and second sacrificial layers.

51. The method of claim 50, further comprising forming a second capacitance control layer between the movable layer and the second sacrificial layer.

52. The method of claim 51, further comprising forming a second protective layer between the second capacitance control layer and the second sacrificial layer.
